(19) United States
(12) Patent Application Publication
(10) Pub. No.: US 2016/0311518 A1
(43) Pub. Date: Oct. 27, 2016

(54) WING STRUCTURE UTILIZING CARBON FIBER SPAR AND SHAPED FOAM

(71) Applicant: James P. Wiebe, Wichita, KS (US)

(72) Inventor: James P. Wiebe, Wichita, KS (US)

(21) Appl. No.: 14/555,471

(22) Filed: Nov. 26, 2014

Related U.S. Application Data
(60) Provisional application No. 61/909,244, filed on Nov. 26, 2013.

(51) Int. Cl. B64C 3/18; B64F 5/00

(52) U.S. Cl. CPC B64C 3/185; B64C 3/187; B64F 5/0009; B64C 2009/005

(57) ABSTRACT

An aircraft wing includes a body including plural composite spars, with plural foam ribs positioned adjacent the spars.

### FIELD OF THE INVENTION

The present invention is a methodology for producing aircraft wings and other structures utilizing carbon fiber spars and shaped foam. This invention is used in substitution of other wing structure methodologies, such as monocoque aluminum; spar/conventional ribs; wood ribs/wood spars/fabric covering; and especially: shaped foam covered with composites.

### BACKGROUND

An aircraft wing traditionally carries loads through either the spar, the surface of the wing, and lift struts or wires. The materials involved in all of these include wood, metal, composites, and fabrics. The vast majority of all aircraft utilize these traditional methods. Modern examples include the Cessna 172.

A methodology exists which involves shaping a foam core to the shape of the wing, then covering the foam core with composites, such as fiberglass or carbon fiber. This process causes loads to be carried through the composite covering. This methodology may be labor intensive in both foam core shaping and in process layup of the composite covering. The resulting structure may be heavier than necessary because of the composite covering, which carries loads non-uniformly along its structure.

Another methodology exists which involves shaping the wing surfaces utilizing composites and molds, and thereafter adding in additional spars and/or ribs. This method requires high expense for mold production and fabrication, and also causes a high weight in the finished product.

### SUMMARY

In one embodiment of the present invention, one or more composite spars are utilized in conjunction with pre-shaped foam ribs. As the load carrying characteristics vs. weight of a composite spar (such as a tubular carbon fiber structure) is a very high ratio, the wing structure is very lightweight and strong relative to other methodologies. By sliding a plurality of foam ribs over the tubular spar(s), the exact final shape of the wing may be achieved without utilizing wing molds and without using excess heavy composite layers on the surface of the wings. As foam ribs may be fabricated utilizing low cost CNC techniques (or injection molded), the final shape of the wing may be designed with multiplicity of angles, as to achieve structural or aerodynamic benefits. This is not possible with hot-wire cut foam cores. A further benefit is that the production cost of uniform tubular carbon fiber structures is low (relative to the cost of carbon fiber produced in wing molds; or laid on the surface of a foam core). Additional benefits to low cost wing construction may be achieved, even if the spars are constructed from tubular aluminum or other metals.

### BRIEF DESCRIPTION OF THE DRAWINGS

FIG. 1 shows an isometric overview of an aircraft wing.

FIG. 2 shows a three view drawing of a typical foam rib.

FIG. 3 shows a cutout (absence of foam ribs) with the presence of the tubular carbon fiber spars, of which there are two in this example.

FIG. 4 shows the attachment of a flap structure to the main body of the wing.

FIG. 5 is a diagram showing just the outboard foam ribs.

FIG. 6 is a diagram showing the structure in the wing, including the spars, control rods, linkages, brackets, and additional spars for the flaps and the ailerons.

FIG. 7 shows the wing upside down, and shows a lift strut attachment point, and also two spar extensions on the base root of the wing.

FIG. 8 is a diagram showing the total structure detail.

FIG. 9 is a diagram showing the wing in conjunction with a typical aircraft design.

### DETAILED DESCRIPTION

The present invention provides a method to produce wings utilizing spars and foam structures:

10) spars; optimally produced from carbon fiber tubing, which carry loads in lift, also in downward force; and furthermore in tension or compression if a lift strut is utilized. The spars are optimally produced from composites (such as carbon fiber). Due to their uniform production methodology, they have predictable strength, weight and cost characteristics.

12) foam structures; which may be machined or molded, and may be of constant or varying shape and size; these foam structures may look like ribs; and may have pockets to allow mounting of brackets, control structures, linkages and other items within the wing. The foam structures may appears as ribs or as larger sections of the wing. The exterior surface of the foam structure is the exact final shape of the wing, with allowance for a surface covering (such as a vinyl applique) or a surface composite (such as fiberglass or carbon fiber cloth, bonded with epoxy or other glue to the foam). The ribs are glued to each other, and to the spars. Brackets and linkages are glued within the rib structure, to enable the attachment of flaps, ailerons and other wing structures.

14) optionally: flaps, in order to increase the coefficient of lift and to reduce the stalling speed. Flaps are a typical component of many wing designs. Some aircraft have been successfully flown without flaps, and they are not necessary in all designs. When utilized, they generally increase the coefficient of lift, and reduce the takeoff and landing speeds.

16) optionally: (but usually) ailerons, in order to allow the aircraft to be controlled in the ‘roll’ axis. Ailerons are a typical and usual component of many wing designs. Some aircraft have been successfully flown without ailersons, and they are not necessary in all designs. (But the vast majority of modern aircraft utilize ailerons). They allow the aircraft to be controlled in the roll axis.

18) control structure thereto: for flaps and ailerons and any other wing based structure (such as additional aircraft requirements: fuel tanks, electrical lighting, spoilers, leading edge slats; Krueger flaps; and so forth). Control structures are usually required to provide linkages and control movements for flaps, ailerons, and other components of the wing structure.

20) accommodation for carry-thru spars (if required). Carry through spars may be accommodated by extending the existing spars through the cockpit structure of the aircraft. Alternatively, the carry-through spar may be slipped inside the spar of the aircraft, as long as the outside diameter of the carry through spar is less than the inside diameter of the wing's spars. The carry-through spar would extend from the left wing to the right wing, via or through the cockpit. The lift (and other components) of the wing would be transmitted into the aircraft through capture of the carry-through spar.

22) accommodation for lift struts (if required). Lift struts are accommodated in this wing design methodology as well. Attachment of lift struts allow lift loads (and negative G loads) to be carried in tension (or compression) into the aircraft structure via lift struts. They may be used in conjunction with carry through spars. They may also be used exclusively, or they may be omitted, depending on load considerations in the carry-through spars.

24) accommodation for spar attachment points (usually required if carry-thru spars are not used). Spar attachment points may be necessary, especially if lift struts are used and carry-through spars are not. This is an attachment point, attached at the root point of each spar, which allows attachment of the wing to the aircraft structure.

26) allowance for a covering on the outer surface of the foam, such as foam-compatible paint; adhesive vinyl; shrinkable Dacron (or other) fabric; or layer(s) of fiberglass or other surface composite coverings. The outer surface of the foam is ideally covered with a protective layer. In very light or ultralight aircraft, this may be paint or another covering, such as adhesive vinyl or fabric. It also may be a composite covering, such as fiberglass or carbon fiber. The utilization of such a composite covering is likely to increase the strength of the wing.

This new methodology may be used with struts which exist primarily in compression, such as when the wing is low mounted to the aircraft cabin, and struts extend upward from the wing to the top area of the aircraft cabin.

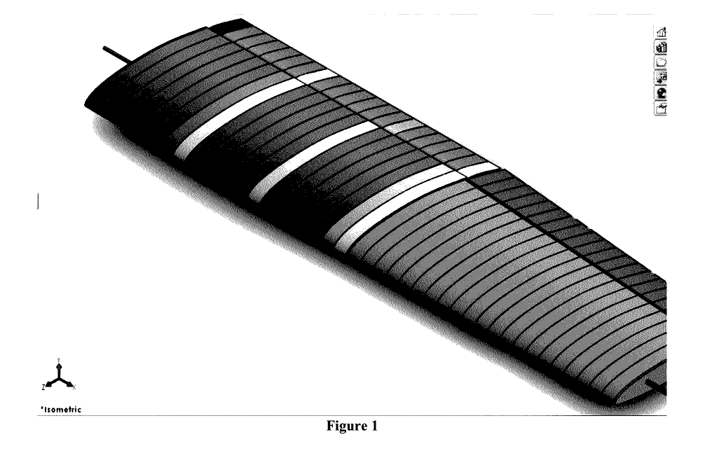

Referring to FIG. 1, ribs are shown, which may be utilized using a CNC machine or molds. The ribs have a multiplicity of shapes; for instance, the ribs of larger inboard section of the wing (at the top and left of the diagram) are constant in size, while the remaining ribs (at the bottom and right of the diagram) taper from mid-wing to the tip. Also shown are other structures—specifically flaps (on the inboard wing) and ailerons (on the outboard wing), and also control and attachment tubes protruding from each end.

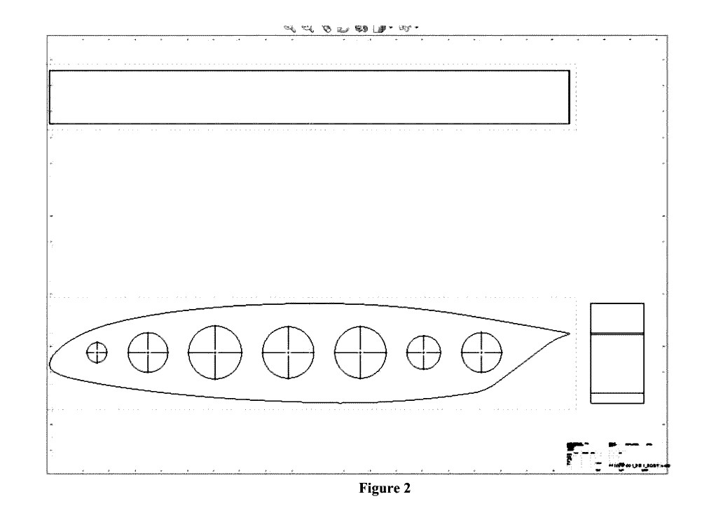

Referring to FIG. 2, while the sample rib is uniformly parallel, the rib may be tapered, or may have pockets to accommodate internal brackets and fittings. Of the holes shown in the rib, one or two (or more) are used for tubular composite spars, while the remainder of the holes are simply present for the purpose of weight lightening. Any such rib may be constructed utilizing a CNC machine or by the use of molds.

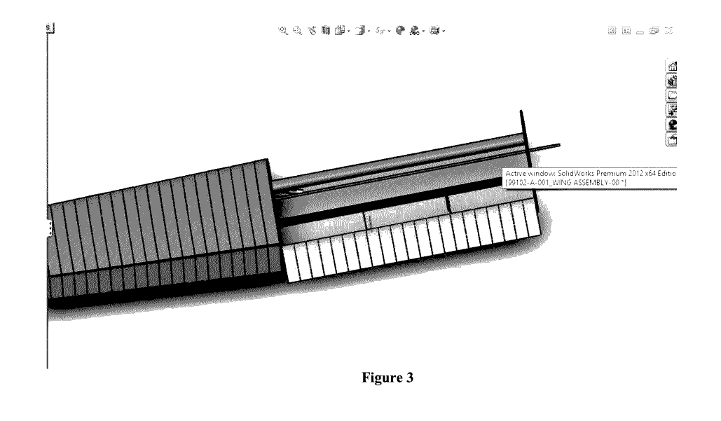

Referring to FIG. 3, the top and bottom spars are shown. The smaller tube shown between them is a control tube, interconnected between cockpit controls and the aileron. Also shown are some of the mechanical mounts for the flap structure.

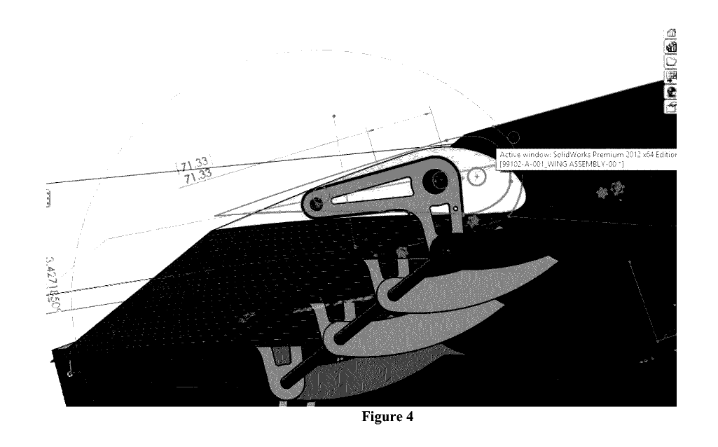

Referring to FIG. 4, the flap structure is also built using smaller foam ribs over a smaller spar. Also shown is how a structure (such as the flap attachment 90 degree bracket) is embedded into the design utilizing a pocket in the foam rib.

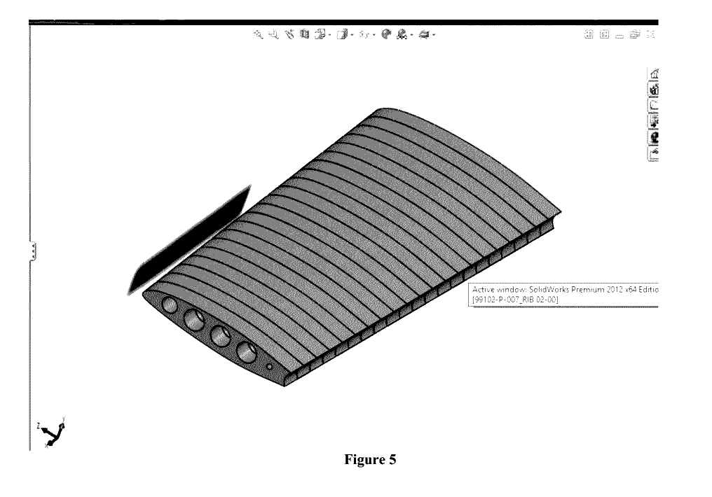

Referring to FIG. 5, a diagram is shown with only outboard foam ribs. All other detail is omitted. The purpose of the diagram is to show that each rib is slightly different in size than its closest mates. CNC machining (or molding) makes it possible accurately create the shape of each rib.

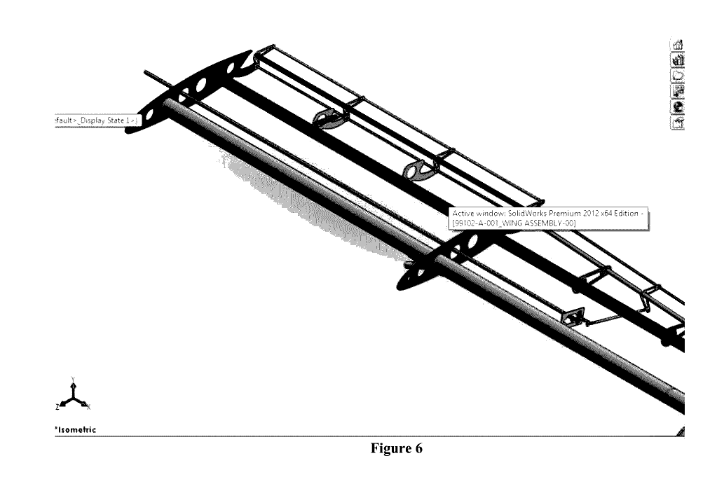

Referring to FIG. 6, a diagram shows the structure in the wing, including the spars, control rods, linkages, brackets, and additional spars for the flaps and the ailerons. No ribs are visible. In this wing design, the main spar is of larger diameter than the rear spar. It is possible to design such a wing with one, two or more spars of similar or different diameters.

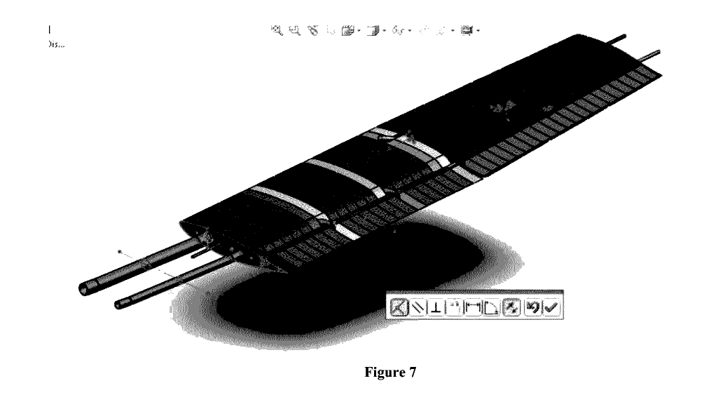

Referring to FIG. 7, attachments to the aircraft fuselage may involve lift struts, although they are not necessary in many configurations (subject to use of spar extensions and spar carry-throughs in the cabin, so that wing loads may be adequately carried to the aircraft structure). The lift strut attachment point is visible in the middle of the wing, pointing out of the wing to the lift. The spar extensions (or carry throughs) are seen in the lower left side of the figure. The small tubes seen exiting the wing on the upper right of the wing are for attachment of wingtip structures (such as hoerner wingtips, winglets, wingtip fuel tanks or other wingtip structures) and may be removed if unnecessary.

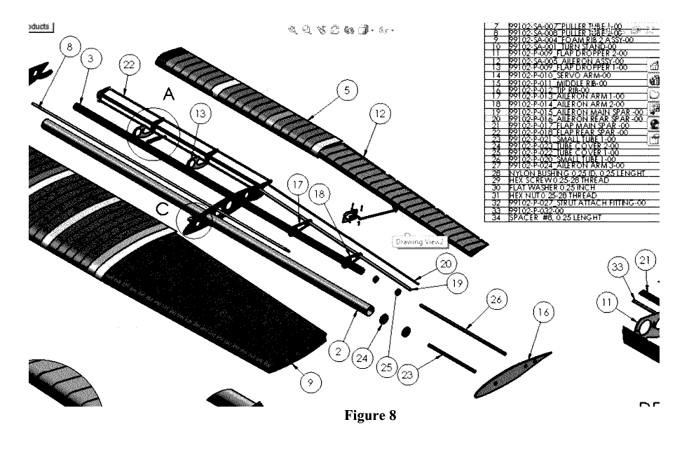

Referring to FIG. 8, there is a diagram showing the total structure detail, including the spars, the foam ribs, the linkages, the brackets, the flap ribs, the aileron ribs, the wingtip structure for assembling a wing structure.

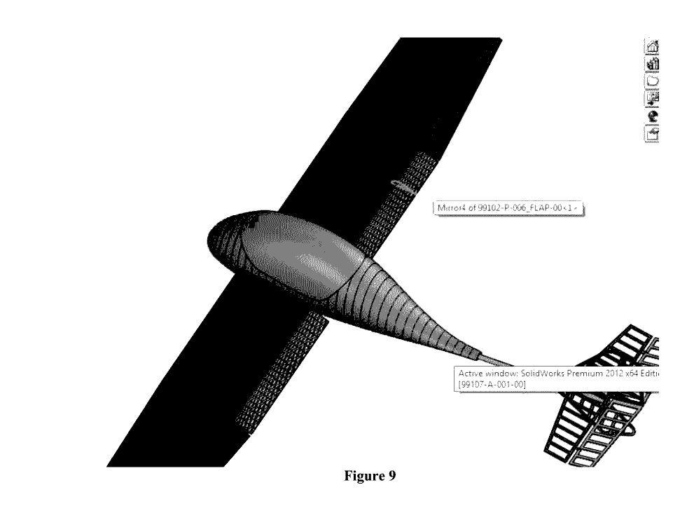

Referring to FIG. 9, there a diagram showing the wing in conjunction with a typical aircraft design. Wing lift struts are not used. Although not shown, a carry-through spar is utilized. Most details are omitted, but the outline of the aircraft in relationship to an aircraft fuselage and structure are clearly shown.
Alternate Description

The present invention provides a way to build a wing utilizing spars of consistent manufacture, uniform weight and strength, and also of foam structures designed to slip over the spars into the final form of the wing. The structure eliminates manual shaping of the foam, and also eliminates the difficulty of covering the foam structure of the wing with composites (unless specifically desired by the wing designer). The final shape of the wing is uniformly exact, allowing excellent control of aerodynamic characteristics. The construction of the wing requires no coarse hand shaping of foam, and provides a final weight which is less than a structure built with a solid foam core and covered with multiple layers of composites. The finished surface of the wing is smoother (has less drag) than structures which have rivets protruding from aluminum surfaces.

What is claimed:

1. An aircraft wing, comprising:
a body including plural composite spars, with plural foam ribs positioned adjacent the spars.
